(19) United States
(12) Patent Application Publication
(10) Pub. No.: US 2019/0344640 A1
(43) Pub. Date: Nov. 14, 2019

(54) HEAT MANAGING DEVICE FOR VEHICLE

(71) Applicant: Toyota Jidosha Kabushiki Kaisha, Toyota-shi (JP)

(72) Inventors: Hidefumi AIKAWA, Nagaizumi-shi (JP); Hideo Nishioka, Toyota-shi (JP); Nobuharu Kakehashi, Toyoake-shi (JP)

(73) Assignee: Toyota Jidosha Kabushiki Kaisha, Toyota-shi (JP)

(21) Appl. No.: 16/368,911

(22) Filed: Mar. 29, 2019

(30) Foreign Application Priority Data
May 14, 2018 (JP) 2018-093078

(51) Int. Cl. B60H 1/00

(52) U.S. Cl. CPC B60H 1/00921; B60H 2001/00949

(57) ABSTRACT

A heat managing device for a vehicle includes: a cooling water circulating path that includes a radiator carrying out heat exchange with outside air, and that circulates cooling water; a coolant circulating path that includes an out-of-cabin device carrying out heat exchange with outside air, that circulates a coolant, and that makes it possible to supply heated air to a vehicle cabin interior by a heat pump cycle; a heat exchanger that carries out heat exchange between the cooling water and the coolant; and a control section that controls the cooling water circulating path so as to cause heat to be absorbed from outside air at the radiator, and that can controls the coolant circulating path so as to cause the coolant to absorb heat from outside air at the out-of-cabin device.

### CROSS-REFERENCE TO RELATED APPLICATION

This application claims priority under 35 USC 119 from Japanese Patent Application No. 2018-093078, filed on May 14, 2018, the disclosure of which is incorporated by reference herein.

### BACKGROUND

### Technical Field

The present disclosure relates to a heat managing device for a vehicle.

### Related Art

Japanese Patent Application Laid-Open (JP-A) No. 2013-1387 discloses a heat pump system for a vehicle in which heat exchange is carried out between a cooling line in which cooling water circulates and a coolant line in which a coolant circulates. In this JP-A No. 2013-1387, by placing electronic equipment (an electric part) on the cooling line, the temperature of the cooling water is raised by using the waste heat generated from the electronic equipment, and the temperature of the coolant is raised by heat exchange being carried out with this cooling water.

In the technique disclosed in JP-A No. 2013-1387, heating can be carried out by raising the temperature of the coolant by utilizing the waste heat of the electronic equipment. However, in order to further improve the heating capacity, a heating device exclusively used therefor, such as a separate heater or the like, must be used.

### SUMMARY

The present disclosure provides a heat managing device for a vehicle that, without providing a dedicated heating device, may ensure a heating capacity that is higher than a structure in which only a single heat exchanger is used as the heat exchanger for heat absorption.

A first aspect of the present disclosure is a heat managing device for a vehicle including: a cooling water circulating path that includes a radiator carrying out heat exchange with outside air, and that circulates cooling water; a coolant circulating path that includes an out-of-cabin device carrying out heat exchange with outside air, that circulates a coolant, and that, by a heat pump cycle, makes it possible to supply heated air to a vehicle cabin interior; a heat exchanger that carries out heat exchange between the cooling water and the coolant; and a control section that can control the cooling water circulating path so as to cause heat to be absorbed from outside air at the radiator, and that can control the coolant circulating path so as to cause the coolant to absorb heat from outside air at the out-of-cabin device.

In the heat managing device for a vehicle relating of the first aspect, the radiator, which carries out heat exchange with outside air, is provided on the cooling water circulating path that circulates cooling water. On the other hand, the out-of-cabin device, which carries out heat exchange with outside air, is provided on the coolant circulating path that circulates a coolant. Further, due to the coolant circulating path circulating the coolant, heated air can be supplied to the vehicle cabin interior by a heat pump cycle. Moreover, the heat managing device for a vehicle includes a control section that controls the cooling water circulating path and the coolant circulating path. This control section can control the respective circulating paths so as to cause the cooling water to absorb heat from outside air at the radiator, and so as to cause the coolant to absorb heat from outside air at the out-of-cabin device. Due thereto, both the radiator and the out-of-cabin device may be made to function as heat exchangers for heat absorption, and a high heating capacity may be ensured as compared with a structure in which only one heat exchanger is made to be a heat exchanger for heat absorption. Further, because the radiator and the out-of-cabin device are used, there is no need to use a dedicated heating device such as another heater or the like. Note that “controls the cooling water circulating path” here means controlling valves and the like that are provided on the cooling water circulating path and changing the flow of the cooling water. “Controls the coolant circulating path” here means controlling valves and the like that are provided on the coolant circulating path and changing the flow of the coolant.

In a second aspect of the present disclosure, in the above first aspect, the control section may further include a mode that controls the cooling water circulating path and the coolant circulating path so as to cause only one of the radiator or the out-of-cabin device to function as a heat exchanger for heat absorption.

In the heat managing device for a vehicle relating of the a second aspect, the cooling water circulating path and the coolant circulating path are controlled by the control section such that only one of the radiator and the out-of-cabin device is made to function as a heat exchanger for heat absorption. Due thereto, in cases in which a high heating capacity is not needed, it is possible to use only one as the heat exchanger for heat absorption.

In a third aspect of the present disclosure, in the above second aspect, an electric part that generates heat maybe disposed on the cooling water circulating path, and due to the control section controlling the coolant circulating path so as to cause the coolant to absorb heat from outside air at the out-of-cabin device and such that the coolant does not flow to the heat exchanger, the control section may raises a temperature of the cooling water, which flows through the cooling water circulating path, by heat from the electric part, and carries out defrosting of the radiator.

In the heat managing device for a vehicle relating of the a third aspect, due to the temperature of the cooling water being raised and defrosting of the radiator being carried out, the radiator may again be utilized as a heat exchanger for heat absorption. Further, by utilizing the waste heat of the electric part, the temperature of the cooling water may be raised and defrosting may be carried out, without requiring another heat source.

In a fourth aspect of the present disclosure, in the above third aspect, may further comprise a shutter that can cut off a flow of outside air to the radiator and the out-of-cabin device, wherein the shutter may be set in a closed state when defrosting of the radiator is carried out.

In the heat managing device for a vehicle relating of the fourth aspect, by setting the shutter in a closed state, traveling wind entering into the radiator may be suppressed even at times when the vehicle is traveling.

In a fifth aspect of the present disclosure, in any one of the first through fourth aspects, the radiator may be disposed so as to be lined up with the out-of-cabin device further toward an upstream side of a flow of outside air than the out-of-cabin device.

In the heat managing device for a vehicle relating of the fifth aspect, the out-of-cabin device, which easily becomes low temperature, frosts-up earlier than the radiator. Therefore, by placing the radiator so as to be lined-up further toward the upstream side of the flow of outside air than the out-of-cabin device, outside air may be made to flow through the radiator and into the out-of-cabin device, even in a state in which the out-of-cabin device has frosted-up.

The heat managing device for a vehicle relating of the first aspect, without using a dedicated heating device, it is possible to ensure a heating capacity that is higher than that of a structure in which only one heat exchanger is used as a heat exchanger for heat absorption.

The heat managing device for a vehicle relating of the second aspect, in accordance with the needed heating capacity, it is possible to select either making two heat exchangers function as heat exchangers for heat absorption, or making only one heat exchanger function as a heat exchanger for heat absorption.

The heat managing device for a vehicle relating of the third aspect, while the heating operation is continued by one heat exchanger, the other heat exchanger may be defrosted.

The heat managing device for a vehicle relating of the fourth aspect, defrosting of the radiator may be carried out effectively.

The heat managing device for a vehicle relating to the fifth aspect, impeding of ventilation to the radiator may be suppressed.

### BRIEF DESCRIPTION OF THE DRAWINGS

Exemplary embodiments of the present disclosure will be described in detail based on the following figures, wherein:

FIG. 1 is a schematic structural drawing showing a heat managing device for a vehicle of a first embodiment, and is a drawing showing the state at the time of a heating operation by both a radiator and an out-of-cabin device;

FIG. 2 is a schematic structural drawing showing the heat managing device for a vehicle of the first embodiment, and is a drawing showing the state at the time of a heating operation by only the out-of-cabin device;

FIG. 3 is a schematic structural drawing showing the heat managing device for a vehicle of the first embodiment, and is a drawing showing the state at the time of a heating operation by only the radiator;

FIG. 4 is a schematic structural drawing showing the heat managing device for a vehicle of the first embodiment, and is a drawing showing the state at the time of a dehumidifying/heating operation;

FIG. 5 is a schematic structural drawing showing the heat managing device for a vehicle of the first embodiment, and is a drawing showing the state at the time of a cooling operation;

FIG. 6 is a schematic structural drawing showing a modified example of the heat managing device for a vehicle of the first embodiment;

FIG. 7 is a schematic structural drawing showing a reference example of the heat managing device for a vehicle of the first embodiment;

FIG. 8 is a schematic structural drawing showing a heat managing device for a vehicle of a second embodiment, and is a drawing showing a state in which shutters are open;

FIG. 9 is a schematic structural drawing showing the heat managing device for a vehicle of the second embodiment, and is a drawing showing a state in which the shutters are closed; and

FIG. 10 is a schematic block drawing showing the heat managing device for a vehicle relating to the first embodiment.

### DETAILED DESCRIPTION

### First Exemplary Embodiment

A heat managing device 10 for a vehicle relating to a first exemplary embodiment is described with reference to the drawings. Note that arrow FR that is shown appropriately in the respective drawings indicates the forward direction of the vehicle.

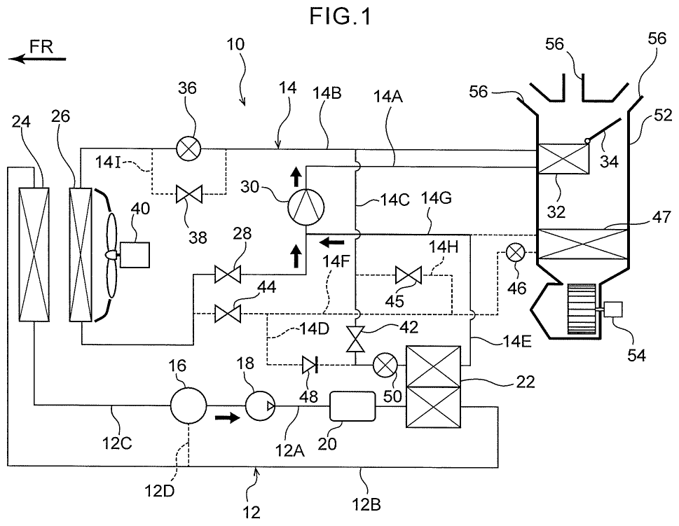

As shown in FIG. 1, the heat managing device 10 for a vehicle relating to the present exemplary embodiment is structured to include a cooling water circulating path 12 that circulates cooling water, and a coolant circulating path 14 that circulates coolant. Note that, in the respective drawings, flow paths into which the cooling water or the coolant can flow are denoted by the solid lines, and flow paths into which the cooling water and the coolant cannot flow are denoted by the dashed lines.

The cooling water circulating path 12 is structured to include a pipe 12A, a pipe 12B, a pipe 12C and a pipe 12D. One end portion of the pipe 12A is connected to a three-way valve 16. Another end portion of the pipe 12A is connected to the cooling water flow-in side of a heat exchanger 22. A water pump (hereinafter abbreviated as “WP”) 18 and an electric part 20 are provided on the pipe 12A in that order from the three-way valve 16 side. Here, examples of the electric part 20 are a motor generator, a battery, an inverter, and the like.

The three-way valve 16 is positioned at the connection point of the pipe 12A, the pipe 12C and the pipe 12D, and is structured so as to be able to switch the flow path. The WP 18 may be a mechanical water pump that operates by using a power unit as the drive source, or may be an electric water pump that operates by using a motor as the drive source. Cooling water flows in the direction of the arrows in the drawing due to the WP 18 being driven. At this time, in the process of passing through the electric part 20, the cooling water absorbs heat that is generated from the electric part 20, and the temperature of the cooling water is raised.

The heat exchanger 22 is a heat exchanger that carries out heat exchange between the cooling water that flows through the cooling water circulating path 12 and the coolant that flows through the coolant circulating path 14. One end portion of the pipe 12B is connected to the cooling water flow-out side of the heat exchanger 22.

Another end portion of the pipe 12B is connected to the cooling water flow-in side of a radiator 24 that carries out heat exchange with outside air. The forking-off point of the pipe 12D is provided midway along the pipe 12B. Therefore, when the flow path is switched by the three-way valve 16, cooling water flows from the pipe 12B through the pipe 12D to the pipe 12A, and the cooling water can be made to not flow to the radiator 24.

One end portion of the pipe 12C is connected to the cooling water flow-out side of the radiator 24. Another end portion of this pipe 12C is connected to the three-way valve 16.

The coolant circulating path 14 is described next. The coolant circulating path 14 is structured to include a pipe 14A, a pipe 14B, a pipe 14C, a pipe 14D, a pipe 14E, a pipe 14F, a pipe 14G; a pipe 14H and a pipe 14I. One end portion of the pipe 14A is connected to a coolant flow-out side of an out-of-cabin device 26 that carries out heat exchange with outside air. Another end portion of the pipe 14A is connected to the coolant flow-in side of an in-cabin condenser 32. Further, a first electromagnetic valve 28 and a compressor 30 are provided on the pipe 14A in that order from the out-of-cabin device 26 side.

The compressor 30 is a device that compresses the coolant, and is structured such that the high-temperature, high-pressure coolant that has been compressed at the compressor 30 is made to flow through the pipe 14A into the in-cabin condenser 32.

Further, the out-of-cabin device 26 is disposed so as to be lined-up with the radiator 24, further toward the vehicle rear side than the radiator 24. An electric fan 40 is provided at the vehicle rear side of the out-of-cabin device 26. Due to the electric fan 40 operating, rotating blades are rotated, and outside air can be blown from the vehicle front side toward the radiator 24 and the out-of-cabin device 26. Therefore, the radiator 24 is disposed further toward the upstream side of the flow of outside air than the out-of-cabin device 26.

One end portion of the pipe 14B is connected to the coolant flow-out side of the in-cabin condenser 32. Another end portion of the pipe 14B is connected to the coolant flow-in side of the out-of-cabin device 26. Further, a first expansion valve 36 is provided on the pipe 14B.

One end portion of the pipe 14C is connected to the pipe 14B between the in-cabin condenser 32 and the first expansion valve 36. Another end portion of the pipe 14C is connected to the pipe 14D. A second electromagnetic valve 42 is provided on the pipe 14C.

One end portion of the pipe 14D is connected to the pipe 14F, and another end portion of the pipe 14D is connected to the coolant flow-in side of the heat exchanger 22. A check valve 48 and a second expansion valve 50 are provided on the pipe 14D, in that order from the pipe 14F side. Further, the pipe 14C is connected to the pipe 14D, between the check valve 48 and the second expansion valve 50.

One end portion of the pipe 14E is connected to the coolant flow-out side of the heat exchanger 22, and another end portion of the pipe 14E is connected to the pipe 14G.

One end portion of the pipe 14F is connected to the pipe 14A, between the out-of-cabin device 26 and the first expansion valve 36. Another end portion of the pipe 14F is connected to the coolant flow-in side of an evaporator 47. A third electromagnetic valve 44 and a third expansion valve 46 are provided on the pipe 14F, in that order from the pipe 14A side.

Here, the evaporator 47 is disposed within an HVAC (Heating, Ventilation and Air Conditioning) unit 52. The HVAC unit 52 has an unillustrated first air suction port that sucks-in air that is within the vehicle cabin (inside air), and an unillustrated second air suction port that sucks-in air that is at the vehicle cabin exterior (outside air).

The HVAC unit 52 has plural blow-out ports 56 that open to the vehicle cabin interior. A blower 54 is provided within the HVAC unit 52 at the side of the evaporator 47 opposite the side at which the blow-out ports 56 are located. Due to the blower 54 being driven, rotating blades are rotated, air is sucked-in from the first air suction port or the second air suction port, and an airflow that is to be blown-out via the blow-out ports 56 is generated.

The in-cabin condenser 32 and an air mix door 34 are provided between the evaporator 47 and the blow-out ports 56. The in-cabin condenser 32 radiates heat due to the coolant passing through the interior thereof. The air mix door 34 is structured so as to be able to open and close. Due to the air mix door 34 being opened, air that has been heated by the in-cabin condenser 32 is guided to the blow-out ports 56. On the other hand, due to the air mix door 34 being closed, the air that has been heated by the in-cabin condenser 32 is cut-off.

One end portion of the pipe 14G is connected to the coolant flow-out side of the evaporator 47. Another end portion of the pipe 14G is connected to the pipe 14A, between the first electromagnetic valve 28 and the compressor 30.

The pipe 14H is disposed so as to connect the pipe 14C and the pipe 14F. Concretely, one end portion of the pipe 14H is connected to the pipe 14C between the second electromagnetic valve 42 and the portion connected to the pipe 14B. Further, another end portion of the pipe 14H is connected to the pipe 14F between the third electromagnetic valve 46 and the portion connected to the pipe 14D. Moreover, a fourth electromagnetic valve 45 is provided on the pipe 14H.

The pipe 14I that bypasses the first expansion valve 36 is connected to the pipe 14B. One end portion of the pipe 14I is connected to the pipe 14B at further toward the upstream side than the first expansion valve 36, and another end portion of the pipe 14I is connected to the pipe 14B at further toward the downstream side than the first expansion valve 36. A fifth electromagnetic valve 38 is provided on the pipe 14I.

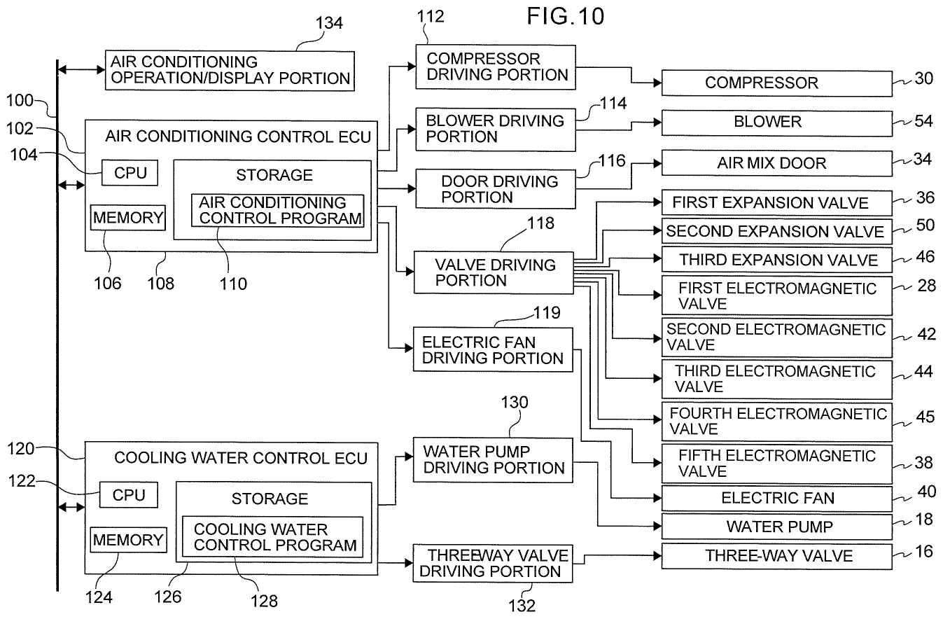

A block diagram of an onboard system that is installed in the vehicle is shown in FIG. 10. Portions that relate to the heat managing system for a vehicle in particular are illustrated in FIG. 10. As shown in FIG. 10, the onboard system has a bus 100, and plural electronic control units and various types of devices are respectively connected to the bus 100. The individual electronic control units are control units that include a CPU (Central Processing Unit), a memory, and a non-volatile storage, and hereinafter, are called ECUs (Electronic Control Units). Among the plural ECUs, an air conditioning control ECU 102 that forms a portion of an air conditioning device, and a cooling water control ECU 120 that forms a portion of a cooling water managing device, are shown in FIG. 10. Further, among the various types of devices, an air conditioning operation/display portion 134, which is for a vehicle occupant to confirm the state of the air conditioning and to input instructions to the air conditioning device, is shown in FIG. 10.

The air conditioning operation/display portion 134 includes a switch for turning operation of the air conditioning device on and off, a ten-key for setting a target temperature for the vehicle cabin interior, and a buttons for instructing dehumidifying and the like (e.g., a button labeled “A/C”). Further, the air conditioning operation/display portion 134 includes a switch for switching to an outside air introducing mode or an inside air circulating mode.

The air conditioning control ECU 102 has a CPU 104, a memory 106, and a non-volatile storage 108 that stores an air conditioning control program 110. The air conditioning control ECU 102 carries out air conditioning control processing, which includes heating operation processing that is described later, due to the air conditioning control program 110 being read-out from the storage 108 and being expanded in the memory 106, and the air conditioning control program 110 that has been expanded in the memory 106 being executed by the CPU 104.

A compressor driving portion 112, a blower driving portion 114, a door driving portion 116, a valve driving portion 118 and an electric fan driving portion 119 are connected to the air conditioning control ECU 102. The compressor driving portion 112 drives the compressor 30 in accordance with an instruction from the air conditioning control ECU 102. The blower driving portion 114 drives the blower 54 in accordance with an instruction from the air conditioning control ECU 102. The door driving portion 116 opens and closes the air mix door 34 in accordance with an instruction from the air conditioning control ECU 102.

In accordance with instructions from the air conditioning control ECU 102, the valve driving portion 118 opens and closes the first expansion valve 36, the second expansion valve 50, the third expansion valve 46, the first electromagnetic valve 28, the second electromagnetic valve 42, the third electromagnetic valve 44, the fourth electromagnetic valve 45, and the fifth electromagnetic valve 38. An electric fan driving portion 119 drives the electric fan 40 in accordance with an instruction from the air conditioning control ECU 102.

The cooling water control ECU 120 has a CPU 122, a memory 124, and a non-volatile storage 126 that stores a cooling water control program 128. The cooling water control ECU 120 carries out cooling water control processing due to the cooling water control program 128 being read-out from the storage 126 and expanded in the memory 124, and the cooling water control program 128 that has been expanded in the memory 124 being executed by the CPU 122. Further, the air conditioning control ECU 102 and the cooling water control ECU 120 correspond to the “control section” of the present invention.

A WP driving portion 130 and a three-way valve driving portion 132 are connected to the cooling water control ECU 120. The WP driving portion 130 drives the WP 18 in accordance with an instruction from the cooling water control ECU 120. The three-way valve driving portion 132 switches the three-way valve 16 in accordance with instructions from the cooling water control ECU 120.

Specific operations of the heat managing device 10 for a vehicle of the present exemplary embodiment are described next.

(Operation 1 at Time of Heating Mode)

At the time of the heating mode, the cooling water control ECU 120 drives the WP 18 via the WP driving portion 130. Further, the three-way valve 16 is set in a state of communicating the pipe 12A and the pipe 12C. Therefore, as shown in FIG. 1, cooling water is sent out from the WP 18, and flows through the electric part 20, the heat exchanger 22, the radiator 24 and the three-way valve 16 in that order, and circulates through the cooling water circulating path 12.

Here, the cooling water that circulates through the cooling water circulating path 12 radiates heat to the coolant at the heat exchanger 22 (causes heat to be absorbed by the coolant), and thereafter, absorbs heat from the outside air at the radiator 24, and moreover, absorbs heat from the electric part 20 as well.

On the other hand, the compressor 30 is driven by the air conditioning control ECU 102 via the compressor driving portion 112, and predetermined expansion valves and electromagnetic valves are opened and closed via the valve driving portion 118. Then, at the in-cabin condenser 32, the high-temperature, high-pressure coolant that has been compressed at the compressor 30 radiates heat to air for vehicle cabin interior air conditioning (heats the air for vehicle cabin interior air conditioning). Here, the air mix door 34 is opened by the door driving portion 116, and the blower 54 is being driven by the blower driving portion 114. Therefore, the air that has been heated at the in-cabin condenser 32 is blown into the vehicle cabin from the blow-out ports 56 (see FIG. 10).

The coolant that has exited from the in-cabin condenser 32 forks-off into the pipe 14B and the pipe 14C. The pressure of the coolant that flows into the pipe 14B is reduced at the first expansion valve 36, and this coolant becomes low-temperature and low-pressure, and absorbs heat from outside air at the out-of-cabin device 26 and evaporates. Thereafter, this coolant flows through the pipe 14A, and passes through the first electromagnetic valve 28, and returns to the compressor 30. In this way, the cooling water circulating path 12 can supply heated air to the vehicle cabin interior by a heat pump cycle.

The coolant, that has exited from the in-cabin condenser 32 and has been forked-off into the pipe 14C, passes through the second electromagnetic valve 42 and the second expansion valve 50 and becomes low-temperature and low-pressure, and, at the heat exchanger 22, this coolant absorbs heat from the cooling water that flows through the cooling water circulating path 12, and evaporates, and passes through the pipe 14E and the pipe 14G and returns to the compressor 30.

As described above, in FIG. 1, the cooling water control ECU 120 controls the cooling water circulating path 12, and the air conditioning control ECU 102 controls the coolant circulating path 14, such that there is an operation mode in which heat is absorbed from outside air at both the radiator 24 and the out-of-cabin device 26.

(Operation 2 at Time of Heating Mode)

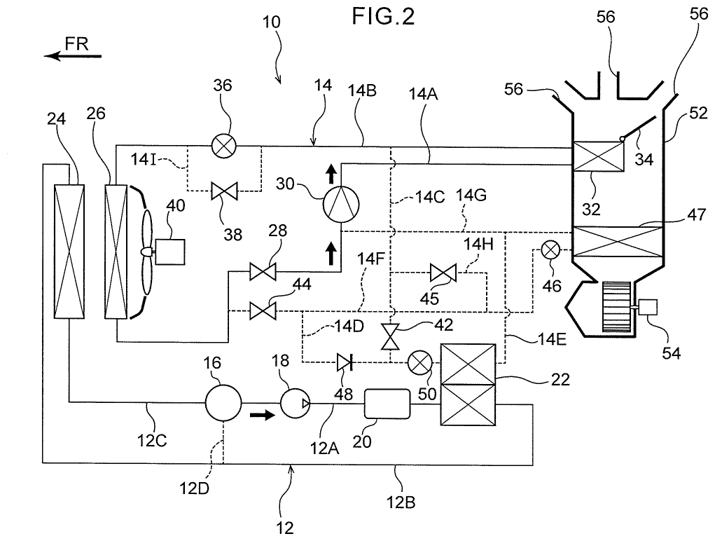

At the time of the heating mode shown in FIG. 2, the second electromagnetic valve 42 and the third electromagnetic valve 44 are closed by the valve driving portion 118 of the air conditioning control ECU 102. Therefore, control is effected such that the coolant of the coolant circulating path 14 does not flow into the heat exchanger 22.

Therefore, at the coolant circulating path 14, the high-temperature, high-pressure coolant that has been compressed at the compressor 30 undergoes heat exchange at the in-cabin condenser 32, and thereafter, the pressure thereof is reduced at the first expansion valve 36, and this coolant becomes low-temperature and low-pressure, and is made to flow into the out-of-cabin device 26. Further, after absorbing heat from outside air at the out-of-cabin device 26, the coolant flows out from the out-of-cabin device 26, and passes through the first electromagnetic valve 28 and returns to the compressor 30.

On the other hand, at the cooling water circulating path 12, the cooling water that is sent out from the WP 18 absorbs heat from the electric part 20, but does not undergo heat exchange at the heat exchanger 22, and therefore, flows into the radiator 24 in a high-temperature state. Then, the radiator 24 is defrosted by the high-temperature cooling water. The cooling water that flows out from the radiator 24 passes through the three-way valve 16 and returns to the WP 18.

As described above, in FIG. 2, the air conditioning control ECU 102 controls the coolant circulating path 14 such that there becomes an operation mode in which the coolant absorbs heat from the outside air at the out-of-cabin device 26. Further, the air conditioning control ECU 102 controls the coolant circulating path 14 such that the coolant absorbs heat from the outside air at the out-of-cabin device 26, and the coolant does not flow to the heat exchanger 22. Due thereto, the temperature of the cooling water that flows through the cooling water circulating path 12 is raised by the heat from the electric part 20, and defrosting of the radiator 24 is carried out. Namely, in FIG. 2, the cooling water circulating path 12 and the coolant circulating path 14 are controlled such that only the out-of-cabin device 26 is made to function as the heat exchanger for heat absorption.

(Operation 3 at Time of Heating Mode)

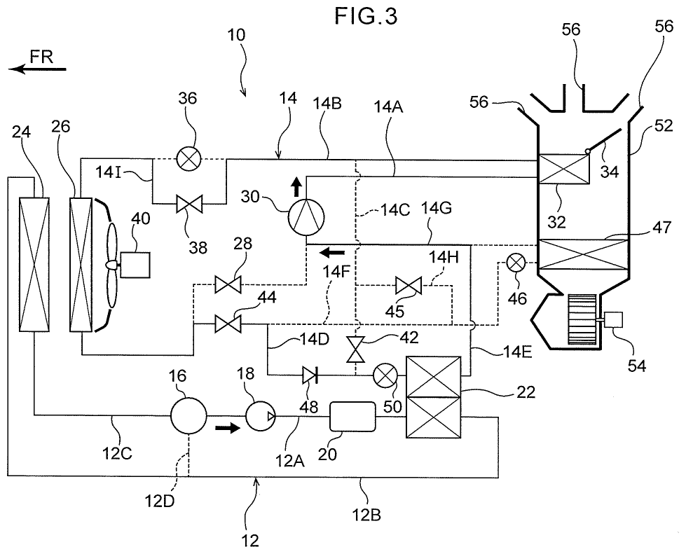

At the time of the heating mode that is shown in FIG. 3, differently than in the case of FIG. 2, heat exchange is carried out between the cooling water and the coolant at the heat exchanger 22. On the other hand, the air conditioning control ECU 102 controls the coolant circulating path 14 so as to carry out defrosting of the out-of-cabin device 26.

Concretely, at the coolant circulating path 14, via the valve driving portion 118, the first expansion valve 36 is closed and the fifth electromagnetic valve 38 is opened (see FIG. 10). Therefore, the high-temperature, high-pressure coolant that has been compressed at the compressor 30 undergoes heat exchange at the in-cabin condenser 32, and thereafter, from the pipe 14B, bypasses the first expansion valve 36 and flows to the pipe 14I. Due to the high-temperature, high-pressure coolant flowing to the out-of-cabin device 26, defrosting of the out-of-cabin device 26 is carried out. The coolant that exits the out-of-cabin device 26 passes through the third electromagnetic valve 44 and the check valve 48, and the pressure thereof is reduced at the second expansion valve 50, and the coolant becomes low-temperature and low-pressure, and this coolant absorbs heat from the cooling water at the heat exchanger 22. Thereafter, the coolant flows through the pipe 14E, the pipe 14G and the pipe 14A, and returns to the compressor 30.

On the other hand, at the cooling water circulating path 12, the cooling water that has been sent out from the WP 18 radiates heat to the coolant at the heat exchanger 22, and thereafter, absorbs heat from the outside air at the radiator 24, and moreover, absorbs heat also from the electric part 20.

As described above, in FIG. 3, the cooling water control ECU 120 controls the cooling water circulating path 12 such that there is an operation mode in which the cooling water absorbs heat from the outside air at the radiator 24. Further, the air conditioning control ECU 102 carries out defrosting of the out-of-cabin device 26 by the coolant whose pressure has been reduced at the compressor 30 and that has become high-temperature and high-pressure. Namely, in FIG. 3, the cooling water circulating path 12 and the coolant circulating path 14 are controlled such that only the radiator 24 is made to function as a heat exchanger for heat absorption.

(Operation at Time of Dehumidifying/Heating Mode)

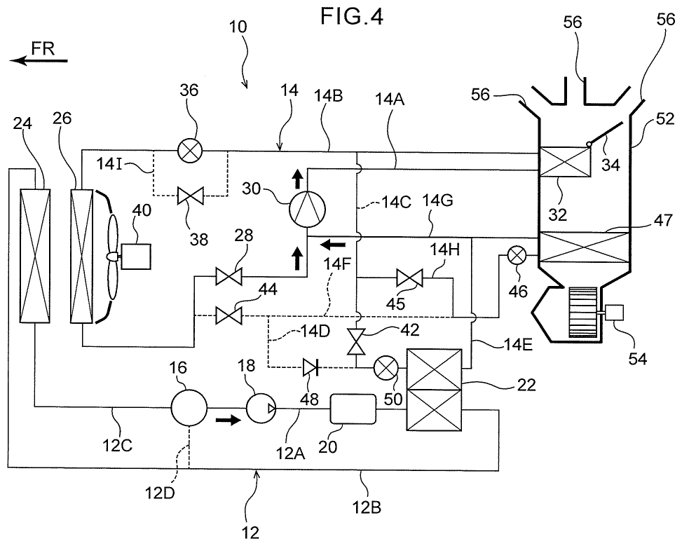

As shown in FIG. 4, at the time of a dehumidifying/heating mode, at the coolant circulating path 14, the coolant that has exited from the in-cabin condenser 32 is forked-off to the pipe 14B and the pipe 14C. The pressure of the coolant that flows through the pipe 14B is reduced at the first expansion valve 36, and the coolant becomes low-temperature and low-pressure, and, at the out-of-cabin device 26, this coolant absorbs heat from the outside air and evaporates. Thereafter, the coolant flows through the pipe 14A, and passes through the first electromagnetic valve 28, and returns to the compressor 30.

The coolant that forks-off into the pipe 14C passes through the second electromagnetic valve 42 and the second expansion valve 50 and becomes low-temperature and low-pressure. At the heat exchanger 22, this coolant absorbs heat from the cooling water, that flows through the cooling water circulating path 12, and evaporates, and passes through the pipe 14E and the pipe 14G and returns to the compressor 30.

Moreover, the coolant which, at the pipe 14C, forks-off to the pipe 14H and passes through the fourth electromagnetic valve 45 and whose pressure is reduced at the third expansion valve 46 and that is low-temperature and low-pressure, flows into the evaporator 47. Then, the coolant that flows out from the evaporator 47 passes through the pipe 14G and returns to the compressor 30. Due thereto, at the evaporator 47, the air within the HVAC unit 52 is dehumidified.

On the other hand, at the cooling water circulating path 12, the cooling water that is sent out from the WP 18 radiates heat to the coolant at the heat exchanger 22, and thereafter, absorbs heat from the outside air at the radiator 24, and moreover, absorbs heat from the electric part 20 as well.

In this way, in FIG. 4, the air conditioning control ECU 102 controls the coolant circulating path 14 and the cooling water control ECU 120 controls the cooling water circulating path 12, such that dehumidifying/heating of the vehicle cabin interior is carried out.

(Operation at Time of Cooling Mode)

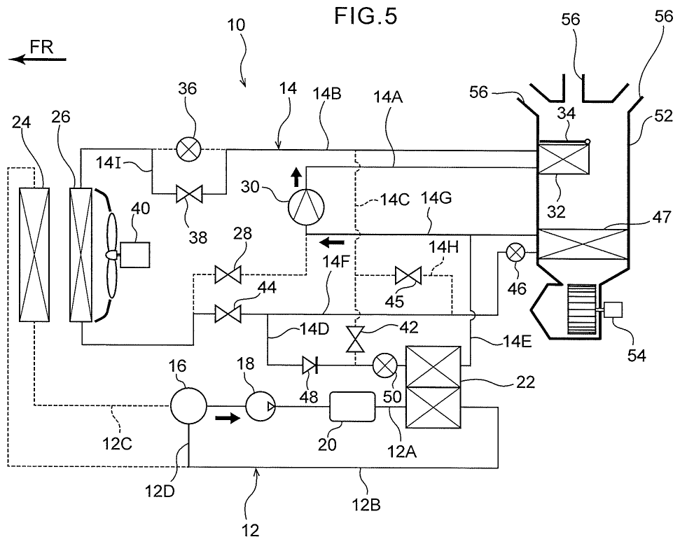

As shown in FIG. 5, at the time of the cooling mode, the air conditioning control ECU 102 closes the air mix door 34 via the door driving portion 116 (see FIG. 10). Therefore, the high-temperature, high-pressure coolant, that has been compressed at the compressor 30 of the coolant circulating path 14, passes through the pipe 14B and the pipe 14I and flows into the out-of-cabin device 26, without radiating heat at the in-cabin condenser 32. Then, the coolant radiates heat to the outside air at the out-of-cabin device 26.

The coolant that has flowed out from the out-of-cabin device 26 is forked-off to the pipe 14F and the pipe 14D. The coolant that flows into the pipe 14D passes through the third electromagnetic valve 44 and the check valve 48, and the pressure thereof is reduced at the second expansion valve 50, and the coolant becomes low-temperature and low-pressure, and absorbs heat from the cooling water at the heat exchanger 22. The coolant that exits from the heat exchanger 22 passes through the pipe 14E and the pipe 14G and returns to the compressor 30.

On the other hand, the pressure of the coolant that flows through the pipe 14F is reduced at the third expansion valve 46, and, at the evaporator 47, this coolant absorbs heat from the air that is within the HVAC unit 52. Therefore, the air within the HVAC unit 52 is set in a state in which heat has been taken therefrom, and becomes cold air, and is blown into the vehicle cabin interior from the blow-out ports 56.

On the other hand, the cooling water control ECU 120 switches the three-way valve 16 via the three-way valve driving portion 132, and controls the cooling water circulating path 12 such that the cooling water does not flow to the radiator 24 (see FIG. 10). Therefore, the cooling water that is sent out from the WP 18 absorbs heat from the electric part 20, and thereafter, at the heat exchanger 22, radiates heat to the coolant of the coolant circulating path 14. Further, the cooling water that exits from the heat exchanger 22 flows from the pipe 12B to the pipe 12D and returns to the WP 18.

As described above, in FIG. 5, the air conditioning control ECU 102 controls the coolant circulating path 14, and the cooling water control ECU 120 controls the cooling water circulating path 12, such that cooling wind is blown into the vehicle cabin interior.

(Operation)

Operation of the present exemplary embodiment is described next.

In the heat managing device 10 for a vehicle of the present exemplary embodiment, as shown in FIG. 1, due to the coolant circulating path 14 circulating the coolant, heated air can be supplied into the vehicle cabin by the heat pump cycle. Further, the cooling water control ECU 120 controls the cooling water circulating path 12 such that, at the radiator 24, the cooling water absorbs heat from the outside air. The air conditioning control ECU 102 controls the coolant circulating path 14 such that, at the out-of-cabin device 26, the coolant absorbs heat from the outside air. Due thereto, both the radiator 24 and the out-of-cabin device 26 may be made to function as heat exchangers for heat absorption, and a high heating capacity may be ensured as compared with a structure in which only one heat exchanger is made to be a heat exchanger for heat absorption. Further, because the radiator 24 and the out-of-cabin device 26 are used, a high heating capacity may be ensured without using a dedicated heating device, such as another heater or the like.

Further, in the present exemplary embodiment, as shown in FIG. 2, the cooling water circulating path 12 and the coolant circulating path 14 may be controlled such that only the out-of-cabin device 26 is made to function as a heat exchanger for heat absorption. In this way, in a case in which there is no need for a high heating capacity, it is possible to use only one of the heat exchangers as a heat exchanger for heat absorption.

Moreover, in FIG. 2, by raising the temperature of the cooling water and carrying out defrosting of the radiator 24, the radiator 24 may again be utilized as a heat exchanger for heat absorption. Further, by utilizing the waste heat of the electric part 20 at this time, defrosting of the radiator 24 may be carried out without requiring another heat source.

In the present exemplary embodiment, as shown in FIG. 3, the cooling water circulating path 12 and the coolant circulating path 14 may be controlled such that only the radiator 24 is made to function as a heat exchanger for absorbing heat. Due thereto, in the same way as in the case of FIG. 2, in a case in which there is no need for a high heating capacity, it is possible to use only one heat exchanger as the heat exchanger for heat absorption. Moreover, by carrying out defrosting of the out-of-cabin device 26, the out-of-cabin device 26 may again be utilized as a heat exchanger for heat absorption.

As described above, by effecting control as in FIG. 2 and FIG. 3, in accordance with the needed heating capacity, it is possible to select whether two heat exchangers (the radiator 24 and the out-of-cabin device 26) are to be made to function as heat exchangers for heat absorption or only one heat exchanger is to be made to function as a heat exchanger for heat absorption. Further, while the heating operation is continued by one of the heat exchangers among the radiator 24 and the out-of-cabin device 26, the other heat exchanger may be defrosted.

Still further, in the present exemplary embodiment, the radiator 24 is disposed further toward the upstream side of the flow of outside air than the out-of-cabin device 26, and, at the time when the electric fan 40 is driven, the outside air that passes through the radiator 24 flows into the out-of-cabin device 26. Here, the out-of-cabin device 26, which becomes low-temperature easily, frosts-up earlier than the radiator 24. Therefore, if the radiator 24 were disposed so as to be lined-up further toward the downstream side of the flow of the outside air than the out-of-cabin device 26, there would be cases in which the flow of outside air to the radiator 24 would be impeded due to the out-of-cabin device 26 frosting-up. In contrast, in the present exemplary embodiment, due to the radiator 24 being disposed so as to be lined-up further toward the upstream side of the flow of outside air than the out-of-cabin device 26, even if there is a state in which the out-of-cabin device 26 has frosted-up, outside air may flow through the radiator into the out-of-cabin device 26. Namely, a high heating capacity may be ensured efficiently.

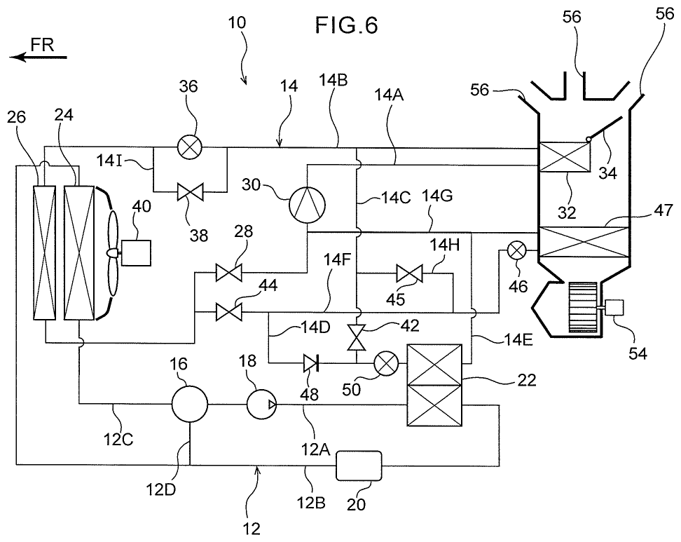

Note that, in the present exemplary embodiment, the radiator 24 is disposed so as to be lined-up further toward the upstream side of the flow of outside air than the out-of-cabin device 26, but there may be the opposite arrangement as shown in the modified example of FIG. 6.

### Modified Example

As shown in FIG. 6, in the present modified example, the radiator 24 is disposed further toward the vehicle rear side than the out-of-cabin device 26. Therefore, at the time when the electric fan 40 is driven, the outside air that has passed through the out-of-cabin device 26 flows into the radiator 24. In this modified example, it suffices to carry out defrosting of the out-of-cabin device 26 in a case in which the out-of-cabin device 26 frosts-up and it is confirmed that ventilation to the radiator 24 is impeded.

### Reference Example

A heat managing device 60 for a vehicle relating to a reference example of the first exemplary embodiment is described next with reference to the drawings. Note that structures that are similar to those of the first exemplary embodiment are denoted by the same reference numerals, and description thereof is omitted as appropriate.

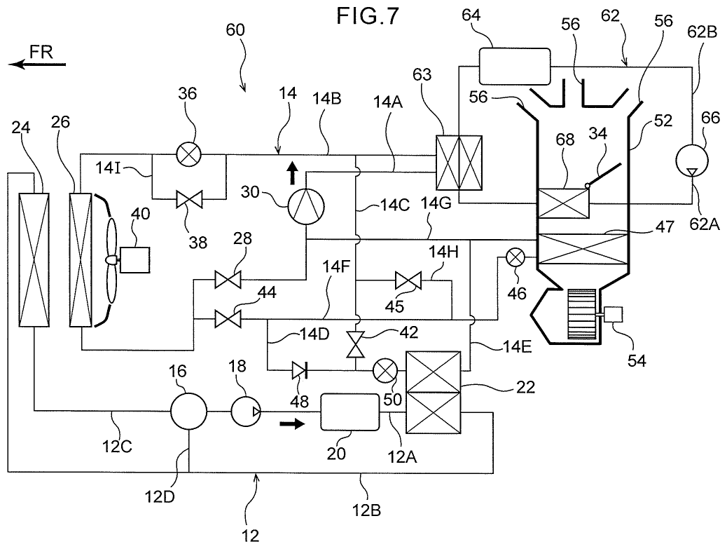

As shown in FIG. 7, at the heat managing device 60 for a vehicle, a water-cooled condenser 63 is provided instead of the in-cabin condenser 32. A cooling water circulating path 62 is connected to the water-cooled condenser 63. Heat exchange is carried out between the cooling water that flows through the cooling water circulating path 62 and the coolant that flows through the coolant circulating path 14.

The cooling water circulating path 62 is structured to include a pipe 62A that connects a WP 66 and the water-cooled condenser 63, and a pipe 62B that returns from the water-cooled condenser 63 to the WP 66. Further, a heater core 68 is provided on the pipe 62A, and the heater core 68 is disposed at the interior of the HVAC unit 52.

Moreover, the air mix door 34 is provided within the HVAC unit 52. This air mix door 34 is structured so as to be able to open and close. Due to the air mix door 34 being opened, air that has been heated at the heater core 68 is guided to the blow-out ports 56. On the other hand, due to the air mix door 34 being closed, the air that has been heated at the heater core 68 is cut-off.

On the other hand, an electric heater 64 is disposed on the pipe 12B. The cooling water that flows through the cooling water circulating path 62 is heated due to the electric heater 64 being energized.

Note that, although illustration of a block diagram of the present exemplary embodiment is omitted, there is a structure in which a separate cooling water control ECU is provided for the cooling water control ECU 120 of FIG. 10. This cooling water control ECU has a water pump driving portion that drives the WP 66. Further, an electric heater driving portion that energizes the electric heater 64 is provided at the cooling water control ECU.

(Operation at Time of Heating Mode)

The operation at the time of the heating mode is described as an example. The high-temperature, high-pressure coolant that has been compressed at the compressor 30 flows into the water-cooled condenser 63 and heats that cooling water that flows through the cooling water circulating path 62. The heated cooling water is, as needed, further heated at the electric heater 64, and is sent out from the WP 66, and flows to the heater core 68. Further, the air within the HVAC unit 52 is warmed at the heater core 68.

Here, the air mix door 34 is opened by the door driving portion 116, and the air blower 54 is being driven by the blower driving portion 114. Therefore, the air, which has been heated at the water-cooled condenser 63 by the heater core 68, is blown from the blow-out ports 56 into the vehicle cabin interior.

(Operation)

Operation of the present exemplary embodiment are described next.

In the present exemplary embodiment, in the same way as in the first exemplary embodiment, by making both the radiator 24 and the out-of-cabin device 26 function as heat exchangers for heat absorption, a high heating capacity may be ensured as compared with a structure in which only one heat exchanger is made to be a heat exchanger for heat absorption. Further, in the present reference example, the water-cooled condenser 63 is provided instead of the in-cabin condenser 32, and moreover, the temperature of the cooling water may be adjusted as needed by using the electric heater 64, and temperature adjustment is easy to carry out.

### Second Exemplary Embodiment

A heat managing device 70 for a vehicle relating to a second exemplary embodiment is described next with reference to the drawings. Note that structures that are similar to those of the first exemplary embodiment are denoted by the same reference numerals, and description thereof is omitted as appropriate.

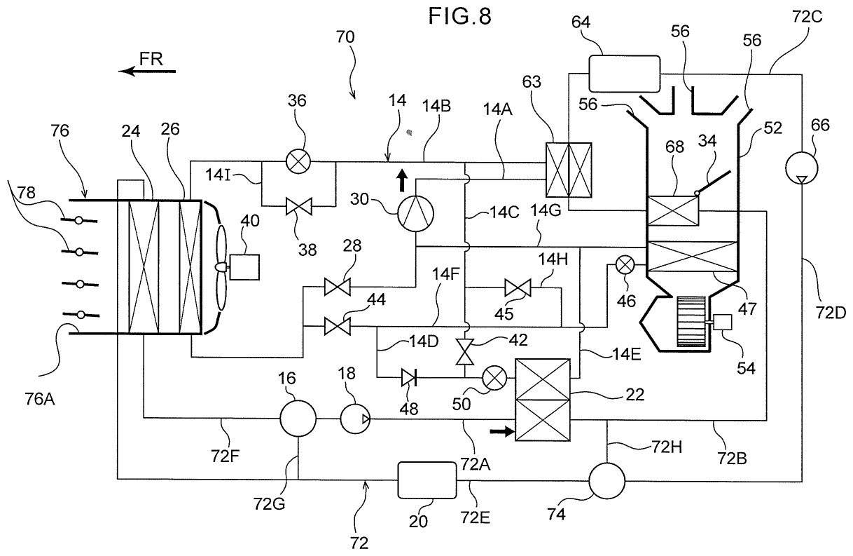

As shown in FIG. 8, at the heat managing device 70 for a vehicle of the present exemplary embodiment, the cooling water circulating path 12 of FIG. 1 and the cooling water circulating path 62 of FIG. 7 are connected, and a cooling water circulating path 72 is structured. The cooling water circulating path 72 is structured to include a pipe 72A, a pipe 72B, a pipe 72C, a pipe 72D, a pipe 72E, a pipe 72F, a pipe 72G and a pipe 72H.

The pipe 72A passes through the WP 18 from the three-way valve 16, and extends to the cooling water flow-in side of the heat exchanger 22. Here, the three-way valve 16 is positioned at the connection point of the pipe 72A, the pipe 72F and the pipe 72G; and is structured so as to be able to switch the flow path. Further, the pipe 72B extends from the cooling water flow-out side of the heat exchanger 22 through the heater core 68 to the cooling water flow-in side of the water-cooled condenser 63.

The pipe 72C passes from the cooling water flow-out side of the cooling water condenser 36 through the electric heater 64, and is connected to the WP 66. Namely, the cooling water circulating path 72 has two WPs. The pipe 72D connects the WP 66 and a three-way valve 74. Here, the three-way valve 74 is positioned at the connection point of the pipe 72D, the pipe 72E and the pipe 72H, and is structured so as to be able to switch the flow path.

The pipe 72E passes from the three-way valve 74 through the electric part 20 and is connected to the cooling water flow-in side of the radiator 24. Further, the pipe 72F extends from the flow-out side of the radiator 24 through the three-way valve 16 to the three-way valve 16.

The present exemplary embodiment is structured such that the radiator 24 and the out-of-cabin device 26 are disposed within a duct 76. The duct 76 is substantially shaped as a box at which an opening portion 76A is formed at the vehicle front side thereof. The radiator 24 and the out-of-cabin device 26 are disposed so as to be lined-up in that order from the side near the opening portion 76A.

The duct 76 has plural shutters 78. Due to these shutters 78 rotating around the axes thereof, the opening portion 76A may be opened and closed. Note that the shutters 78 are structured so as to be driven by an unillustrated shutter driving portion.

(Operation at Time of Heating Mode)

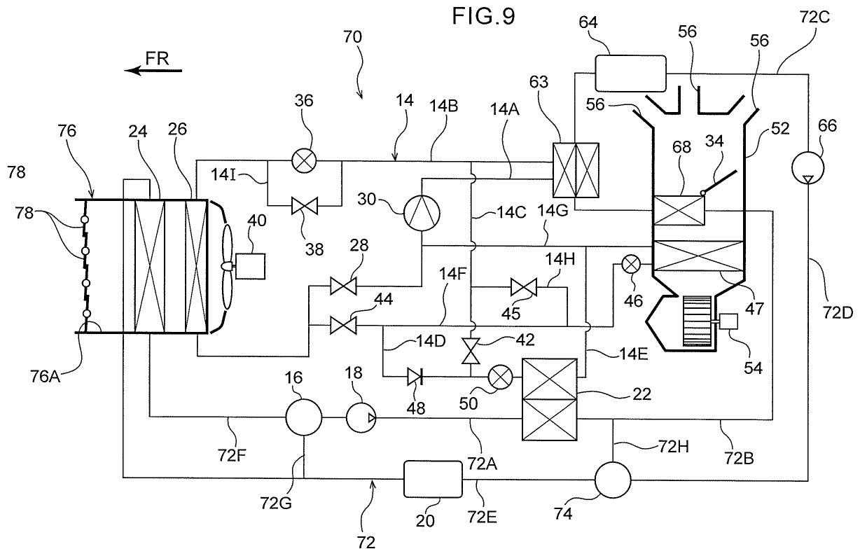

Operation at the time of the heating mode is described as an example. Note that, in FIG. 8 and FIG. 9, all of the pipes that structure the coolant circulating path 14 and the cooling water circulating path 72 are drawn as solid lines, but, in actuality, the coolant and the cooling water flow through only some of the flow paths.

At the time of the heating mode, the high-temperature, high-pressure coolant that has been compressed at the compressor 30 flows into the water-cooled condenser 63, and heats the cooling water that flows through the cooling water circulating path 62. The coolant that exits from the water-cooled condenser 63 flows through the pipe 14B, and the pressure thereof is reduced at the first expansion valve 36, and the coolant becomes low-temperature and low-pressure, and this coolant absorbs heat from the outside air at the out-of-cabin device 26 and is evaporated.

On the other hand, the cooling water, that has absorbed heat from the coolant at the water-cooled condenser 63 of the cooling water circulating path 72, is, as needed, further heated by the electric heater 64, and is sent out from the WP 66, and passes through the three-way valve 74 and flows to the pipe 72H and the pipe 72B, and flows into the heater core 68. Further, at the heater core 68, the air within the HVAC unit 52 is warmed.

(Operation at Time of Radiator Defrosting)

At the time of carrying out defrosting of the radiator 24, at the coolant circulating path 14, the high-temperature, high-pressure coolant that has been compressed at the compressor 30 undergoes heat exchange at the in-cabin condenser 32. Thereafter, the pressure thereof is reduced at the first expansion valve 36, and the coolant becomes low-temperature and low-pressure, and this coolant flows into the out-of-cabin device 26. Further, the coolant absorbs heat from the outside air at the out-of-cabin device 26, and thereafter, flows out from the out-of-cabin device 26 and passes through the first electromagnetic valve 28 and returns to the compressor 30.

On the other hand, at the cooling water circulating path 72, the cooling water that is sent out from the WP 18 passes through the three-way valve 74, flows to the pipe 72E, and absorbs heat from the electric part 20. Then, in a high-temperature state, the cooling water flows into the radiator 24 and defrosts the radiator 24. The cooling water that flows out from the radiator 24 passes through the three-way valve 16 and returns to the WP 18.

Here, at the time of dehumidifying/heating, as shown in FIG. 9, the shutters 78 of the duct 76 are closed. Further, driving of the electric fan 40 is stopped. Due thereto, even at times when the vehicle is traveling, traveling wind entering into the duct 76 is suppressed. Namely, in the present exemplary embodiment, the shutters 78 are set in closed states at the time when defrosting of the radiator is carried out.

(Operation)

Operation of the present exemplary embodiment are described next.

In the present exemplary embodiment, due to the shutters 78 being set in closed states at the time of defrosting the radiator 24, traveling wind entering into the radiator 24 may be suppressed even at times when the vehicle is traveling. As a result, defrosting of the radiator 24 may be carried out effectively.

Note that the present exemplary embodiment describes operation at the time of defrosting the radiator 24, but the same holds also in cases of defrosting the out-of-cabin device 26. Namely, at the time of carrying out defrosting of the out-of-cabin device 26, by closing the shutters 78 of the duct 76, traveling wind entering into the out-of-cabin device 26 is suppressed, and defrosting of the out-of-cabin device 26 may be carried out effectively.

Although heat managing devices for a vehicle relating to a first and second exemplary embodiment have been described above, the present invention may, of course, be implemented in various forms within a scope that does not depart from the gist thereof.

1. A heat managing device for a vehicle, the heat managing device comprising:
a cooling water circulating path that includes a radiator carrying out heat exchange with outside air, and that circulates cooling water;
a coolant circulating path that includes an out-of-cabin device carrying out heat exchange with outside air, that circulates a coolant, and that, by a heat pump cycle, makes it possible to supply heated air to a vehicle cabin interior;
a heat exchanger that carries out heat exchange between the cooling water and the coolant; and
a control section that can control the cooling water circulating path so as to cause heat to be absorbed from outside air at the radiator, and that can control the coolant circulating path so as to cause the coolant to absorb heat from outside air at the out-of-cabin device.

2. The heat managing device for a vehicle of claim 1, wherein the control section further includes a mode that controls the cooling water circulating path and the coolant circulating path so as to cause only one of the radiator or the out-of-cabin device to function as a heat exchanger for heat absorption.

3. The heat managing device for a vehicle of claim 2, wherein:
an electric part that generates heat is disposed on the cooling water circulating path, and
due to the control section controlling the coolant circulating path so as to cause the coolant to absorb heat from outside air at the out-of-cabin device and such that the coolant does not flow to the heat exchanger, the control section raises a temperature of the cooling water, which flows through the cooling water circulating path, by heat from the electric part, and carries out defrosting of the radiator.

4. The heat managing device for a vehicle of claim 3, further comprising a shutter that can cut off a flow of outside air to the radiator and the out-of-cabin device,
wherein the shutter is set in a closed state when defrosting of the radiator is carried out.

5. The heat managing device for a vehicle of claim 1, wherein the radiator is disposed so as to be lined up with the out-of-cabin device further toward an upstream side of a flow of outside air than the out-of-cabin device.
